(19) United States
(12) Patent Application Publication
(10) Pub. No.: US 2016/0257259 A1
(43) Pub. Date: Sep. 8, 2016

(54) DUAL PURPOSE LUGGAGE RACK

(71) Applicant: Eran PERRY, Tel Aviv (IL)

(72) Inventor: Eran PERRY, Tel Aviv (IL)

(21) Appl. No.: 15/026,982

(22) PCT Filed: Aug. 4, 2014
(86) PCT No.: PCT/IL2014/050705

§ 371 Date: Apr. 3, 2016

Related U.S. Application Data
(60) Provisional application No. 61/894,449, filed on Oct. 23, 2013.

(51) Int. Cl. B60R 9/045; G01S 19/14; G09F 21/04; B60R 11/02

(52) U.S. Cl. CPC B60R 9/045; B60R 11/0235; G01S 19/14; G09F 21/04

(57) ABSTRACT

The invention consists of a luggage holder adapted to be attached to the outer surface of a vehicle, wherein the surface of said luggage holder comprises a first and second largely planar portions that are adapted to be rotated about a horizontal axis to a vertical disposition in which it can display visual information to surrounding vehicles. Said first and second portions further having solid bars allowing the mounting and fastening of luggage. Upon said portions, advertisements may be displayed, be they static print displays, or dynamic electronic displays such as LCD screens, LEDs, or the like. To provide an interactive, controlled, self-sustained advertising system along with a dynamic rotatable luggage rack.

### FIELD OF THE INVENTION

The present invention relates to the field of vehicular transport, more specifically to luggage holding and mobile advertising systems for every vehicle.

### BACKGROUND OF THE INVENTION

Automotive transport is an integral part of modern conveyance. With such conveyance, luggage must also frequently be transported in addition to passengers. An external luggage rack can provide a felicitous solution to the compounded difficulties of transporting large amounts of luggage, unwieldy parcels, and the like. As will be clear to the astute observer, luggage racks when not in use serve no actual function, only increasing the sprung mass of the vehicle with no further second functional purpose. Thus there exists a long-felt need for a second use for luggage racks.

In a seemingly unrelated vein, taxi drivers face challenges obtaining fares due to competition from various sources including the sudden encroachment of smartphone-based ridesharing solutions. Taxi stations as well as independent taxi drivers need to advertise their existing business. Their business is also their property, their taxi.

As is known to the modern city dwellers amongst us, taxi drivers carry luggage for passengers with great frequency. Urban travel, passengers traveling to airports, hotel arrivals, and the like often require taxi services having luggage storage.

In this vein several patents are discussed, including their strengths, weaknesses, and apparent deficiencies.

U.S. Pat. No. 7,154,383(B2) discloses a dynamic mobile advertising system . It allows for vehicular advertising exploiting vehicle motion.

WO2007076618(A1) discloses a system for displaying visual messages on a vehicle. This system is solely an advertising system with no further provision.

DE9102066(U1) describes a folding, horizontally and vertically rotatable plate mounted on top of a vehicle, that appears to be just a component composed above a car. It does not allow further uses for advertising or luggage carrying,

JP2010026474(A) describes an advertising sign outside a vehicle, along with an inside advertising sign. This patent solves a need for advertising but does not serve for luggage conveyance. It comprises a rigid reinforced screen attached to the inside or outside of a vehicle.

U.S. Pat. No. 6,812,851(B1) discloses apparatuses for displaying information on vehicles and no further function.

WO2013022671 (A1) describes a cargo accessory folding mechanism, enabling the sole use of luggage carrying and folding of the mechanism, with no function of advertising possible.

There seems to be only a one purpose rack for taxi drivers, either for luggage or advertising. It is thus a long felt need to provide a multi-function for such racks even when not serving their ostensible primary function.

### SUMMARY OF THE INVENTION

The invention consists A luggage holder adapted to be attached to the outer surface of a vehicle having a surface that comprises a first and second largely planar portions that can be rotated from a horizontally disposed to a vertically disposed position, as shown in FIGS. 1 and 2 (for example), respectively. Upon both portions, advertisements may be displayed, be they static print displays, or dynamic electronic displays such as LCD screens, LEDs, or the like. When closed the device serves as a luggage holding device, where said first and second portions further having solid bars allowing the mounting and fastening of luggage. While when opened the device serves as a substrate for advertisement.

Said solid bars are preferably made from a strong solid material able to withstand the weight of luggage without deforming The bars also serve as fastening means as to allow binding luggage with various known fasteners such as ropes.

The foregoing embodiments of the invention have been described and illustrated in conjunction with systems and methods thereof, which are meant to be merely illustrative, and not limiting. Furthermore just as every particular reference may embody particular methods/systems, yet not require such, ultimately such teaching is meant for all expressions notwithstanding the use of particular embodiments.

### BRIEF DESCRIPTION OF THE DRAWINGS

Embodiments and features of the present invention are described herein in conjunction with the following drawings:

FIG. 1 is a depiction of the device in its lowered disposition for a side display embodiment of the invention;

FIG. 2 is a delineation of the device in its raised ‘advertising’ disposition for a side display embodiment of the invention;

FIG. 3 is a depiction of the device in its lowered disposition for a front/read display embodiment of the invention;

FIG. 4 is a delineation of the device in its raised ‘advertising’ disposition for a front/read display embodiment of the invention;

FIG. 5 is a front view of the device for a front/rear display embodiment of the invention;

FIG. 6 is a rear view of the device for a front/rear display embodiment of the invention;

FIG. 7 is a depiction of the device in its raised ‘luggage rack’ disposition for trunk-mounted embodiment of the invention;

FIG. 8 is a delineation of the device in its raised ‘advertising’ disposition for a front/read display embodiment of the invention.

It should be understood that the drawings are not necessarily drawn to scale.

### DETAILED DESCRIPTION OF THE PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

The invention comprises a system and method for advertising signage serving dual purpose as a luggage carrier.

The invention is a device that is attached to the trunk lid or the roof of a vehicle. The device may be used to carry luggage in the manner of ordinary racks that may be found in the art. However there is a further, second vital function of use inherent to the device, which may not be evident to even the perspicuous observer; for a flat section of this seemingly simple luggage carrier in fact may be rotated upon a hidden axle, allowing it to stand upright, perpendicular to the hood of the car, and to boldly display information, for example implementing an electronic interactive billboard, to illustrious effect. Thus surrounding vehicles (especially vehicles following the vehicle bearing the device) may be bombarded with visual information at will. The billboard may serve as a projecting device, allowing for remote broadcast of commercials, advertisements, or other visual information in conformance with the location, appearance and time.

The patent is designed to solve compounded difficulties that threaten to encroach upon the liberties of modern life. To wit, today there are innumerable solutions for carrying cargo on vehicles; however, the various solutions available on the market do not offer an alternate use for the carrier, in the case that the carrier is not being used for its ostensible purpose, namely that of carrying cargo.

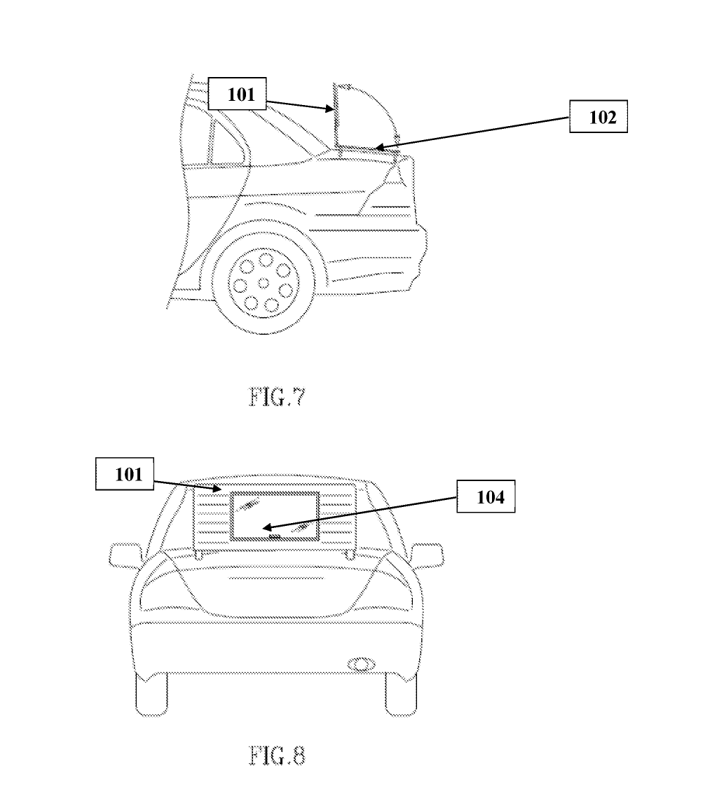

Thus the invention felicitously comes to provide this alternate use. The invention comprises a device that may largely cover the trunk of a vehicle, said device being used for not one, but two distinct and separate purposes, an intriguing and surprising duality which cannot be stressed highly enough. Firstly, the device is usable as a rack or holder for luggage. This is shown in one embodiment in FIGS. 7,8, wherein one sees the rack attached to the back hood of a car. The rack may be attached by any of a variety of known attachment means, including but not limited to screws, nails, glue, tape, rivets, bungie cords, rope, nuts, bolts, tacks, adhesives, staples, welds, brazing, solder, tongue-in-groove systems, latches, locks, or otherwise.

Besides serving the function of a luggage rack, the device carries a second, distinct, and unrelated use. The top section of the luggage rack (see FIGS. 7,8) may rotate about a pivot or axis, being held in place by a hinge attached also to the base which is in turn attached to the vehicle as mentioned above. By suitable unfolding this largely planar top section, the flat section may now display information to drivers behind the car carrying the device, and may serve as (for example) an interactive billboard upon which advertisements are displayed, possibly being controlled remotely by a control center.

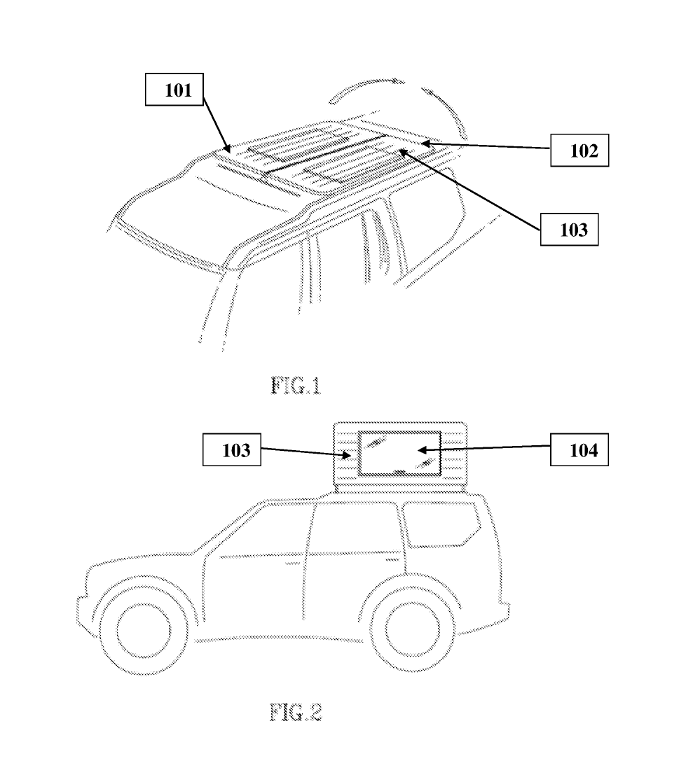

Additional embodiments are shown in FIGS. 1-6. In these figures a roof-mounted display 104 is shown. FIGS. 1-2 show an embodiment adapted for displaying information to the left and right sides of the vehicle (FIG. 2), and which folds down flush with the roof of the vehicle (FIG. 1).

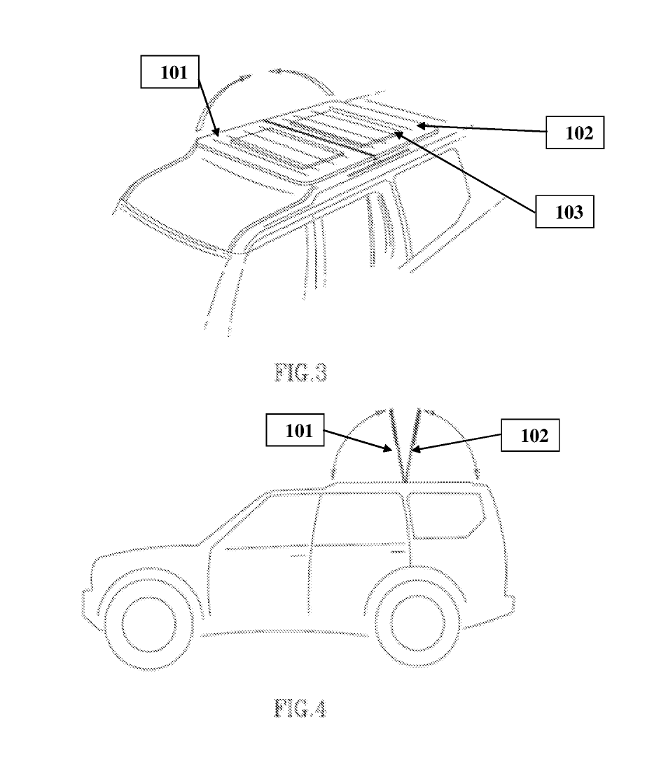

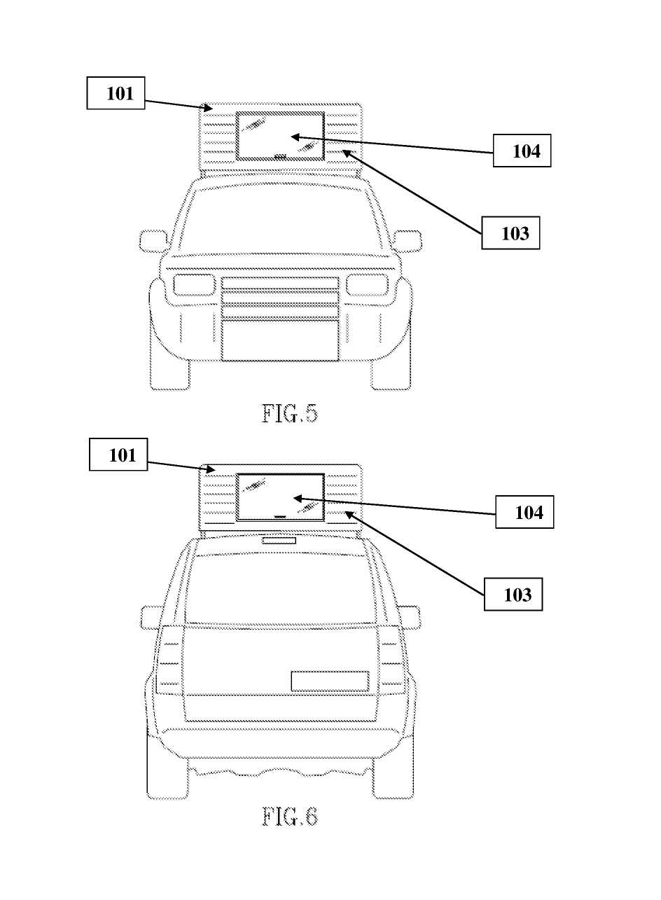

As seen in FIGS. 3,4,5,6 the roof mounted display 104 when deployed allows displaying information to observers both in front of and behind the vehicle in question (FIGS. 5,6).When folded, it is flush to the roof of the vehicle (FIG. 1).

In addition, the system is in some embodiments capable of transmitting information to a control center for purposes of analyzing vehicle location, surrounding visual scene, and other sensed information, for the purpose of more intelligently choosing and/or creating custom advertisements for broadcast to a particular vehicle.

The main innovation of the invention stems from the ability of the device to be useful in not one but two entirely different contexts, namely both as a cargo carrier, and furthermore as an interactive billboard.

The system comprises, in one embodiment, the following elements:

A. Mechanical appurtenance attached to the rear trunk lid of a vehicle, adapted to be as a luggage carrier.

B. Spring system adapted to position the top panel of the device in a largely vertical position, presenting a planar area to any drivers behind the vehicle bearing the device in question.

C. Waterproof TV screen connected to the device.

D. Rear video cameras connected to the TV screen.

E. GPS system.

F. Computerized system including, in certain embodiments, the following features:
a. Transmission and reception capability in wireless or wired modes.
b. Capacity for planning advertisements and other broadcasts by location, time and appearance.
c. Computerized system which is attached to the screen, which is capable of displaying a desired advertisement.
d. Computerized system which is connected to cameras and can receive and transmit images.
e. Computerized system which is connected to the GPS and can receive and transmit location.

G. A remote control center enabling the control of an interactive advertising.

It is within provision of the invention that all electrical systems of the invention are operated using the car battery, and/or solar panel, and/or a separate energy source such as a primary or secondary battery.

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

1. A luggage holder adapted to be attached to the outer surface of a vehicle, wherein the surface of said luggage holder comprises a first 101 and second 102 largely planar portions that are adapted to be rotated about a horizontal axis to a vertical disposition in which it can display visual information to surrounding vehicles; said first and second portions further having solid bars 103 allowing the mounting and fastening of luggage.

2. The luggage holder of claim 1 wherein at least 1 of said portions comprises an interactive electronic display 104.

3. The device of claim 2 wherein said electronic display 104 is powered by a source selected from the group consisting of: said car's car battery, a solar panel, a primary battery; a secondary battery.

4. The device of claim 1 further comprising a spring system adapted to position at least 1 of said portions of said device in a largely vertical position, thereby presenting a planar area to any drivers behind the vehicle bearing the device in question.

5. The device of claim 2 wherein said display comprises a waterproof TV screen.

6. The device of claim 5 further comprising rear video cameras connected to said TV screen.

7. The device of claim 1, mounted on the roof of said vehicle.

8. The device of claim 1, mounted to the rear of said vehicle.

9. The device of claim 1 further comprising a GPS system.

10. The device of claim 1 further comprising transmission and reception capability in wireless or wired modes.

11. The device of claim 1 further comprising capacity for planning advertisements and other broadcasts by location, time and appearance.

12. The device of claim 1 further comprising a computerized system which is attached to the screen, which is capable of displaying a desired advertisement.

13. The device of claim 1 further comprising a computerized system which is connected to cameras and can receive and transmit images.

14. The device of claim 1 further comprising a computerized system which is connected to the GPS and can receive and transmit location.

15. The device of claim 1 further comprising a remote control center enabling the control of an interactive advertising.
